(19) United States
(12) Patent Application Publication
(10) Pub. No.: US 2014/0170012 A1
(43) Pub. Date: Jun. 19, 2014

(54) Additive manufacturing using partially sintered layers

(71) Applicant: UNITED TECHNOLOGIES CORPORATION, Hartford, CT (US)

(72) Inventors: Robert P. Delisle, Colchester, CT (US); Christopher F. O'Neill, Hebron, CT (US); Paul R. Faughnan, East Hampton, CT (US); Jesse R. Boyer, Manchester, CT (US)

(73) Assignee: United Technologies Corporation, Hartford, CT (US)

(21) Appl. No.: 13/718,385

(22) Filed: Dec. 18, 2012

(51) Int. Cl. B22F 3/16; B29C 67/00; B22F 3/00

(52) U.S. Cl. CPC B22F 3/16; B22F 3/003; B29C 67/0077
USPC 419/6; 156/380.9; 425/78; 156/242

(57) ABSTRACT

The invention relates to an additive manufacturing apparatus and method. According to the invention, an additive manufacturing apparatus includes a material supply system. The material supply system delivers layers of partially sintered pulverant material to an additive manufacturing device.

### BACKGROUND

This invention relates generally to the field of additive manufacturing. In particular, the present invention relates to the feed material used to create additively manufactured articles.

Additive manufacturing is an established but growing technology. In its broadest definition, additive manufacturing is any layerwise construction of articles from thin layers of feed material. Additive manufacturing may involve applying liquid, layer or powder material to a workstage, then sintering, curing, melting, and/or cutting to create a layer. The process is repeated up to several thousand times to construct the desired finished component or article.

Various types of additive manufacturing are known. For example, stereolithography (additively manufacturing objects from layers of a cured photosensitive liquid), Electron Beam Melting (using a pulverant material as feedstock and selectively melting the pulverant material using an electron beam), Laser Additive Manufacturing (using a pulverant material as a feedstock and selectively melting the pulverant material using a laser), and Laser Object Manufacturing (applying thin, solid sheets of material over a workstage and using a laser to cut away unwanted portions) are known. Each method has advantages and disadvantages. For example, one disadvantage of Laser Additive Manufacturing is that as pulverant material is made from increasingly fine particles as required for ever-thinner layers, the pulverant material may begin to clump, and the increased surface area to volume ratio of finer particles results in higher oxidation rates.

There are some known technologies which attempt to mitigate the difficulties associated with powder feedstock. For example, sinterpaper is a commercially available product that consists of a paper fiber with embedded metallic sinterable powders. During laser sintering, the paper fiber is burned off, leaving only the sintered metal. However, sinterpaper may leave carbonaceous residue, and suffers from uneven distribution of pulverant material throughout the paper fibers.

### SUMMARY

The invention relates to an additive manufacturing apparatus and method. According to the invention, an additive manufacturing apparatus includes a material supply system. The material supply system delivers layers of partially sintered pulverant material to an additive manufacturing device. Furthermore, the invention includes a method of forming an object using layers of partially sintered pulverant material, which are selectively sintered to form the object.

### BRIEF DESCRIPTION OF THE DRAWINGS

FIG. 1 is a perspective view of an additive manufacturing device incorporating the partially sintered layer material.

FIG. 2 is a simplified cross-sectional view of a partially sintered sheet material.

### DETAILED DESCRIPTION

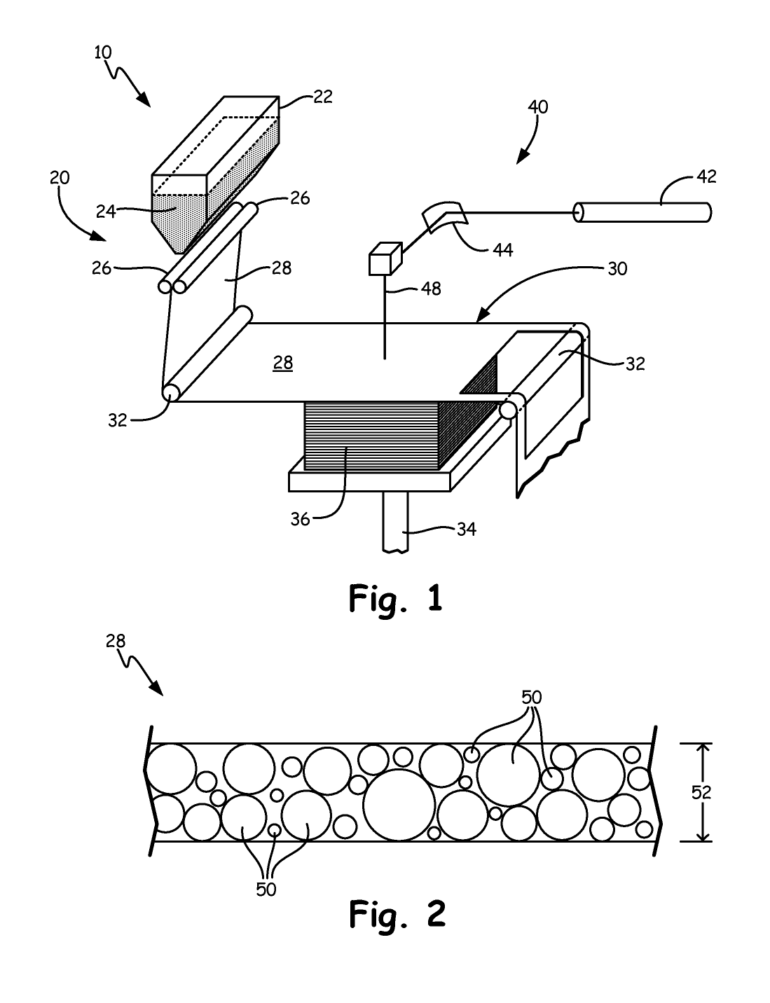

FIG. 1 is a perspective view of additive manufacturing apparatus 10. FIG. 1 shows material supply section 20, workstage 30, and radiation system 40 of additive manufacturing apparatus 10.

Material supply section 20 as shown in FIG. 1 includes hopper 22, pulverant material 24, rollers 26, and partially sintered layer 28. Hopper 22 is any container for holding pulverant material 24, and may expel pulverant material 24 through an opening. Pulverant material 24 is any material suitable for additive manufacturing, such as powdered metals and/or powdered polymers. For example, pulverant material 24 may include a high-temperature superalloy. In some embodiments, pulverant material 24 may include a mixture of powdered materials, at least one of which is sinterable. These materials may be pre-mixed, or may be dispensed from a plurality of hoppers. In this embodiment, opposed rollers 26 act as a layer forming member. Rollers 26 are separated by a thickness, and in some embodiments the rollers are heated. One or both of rollers 26 may also be attached to a motor (not shown) in order to rotate at a specified speed. Further, one or both of rollers 26 may be heated. Under pressure and temperature, pulverant material 24 may sinter, or partially melt, causing granules of pulverant material 24 to bond to one another. As a result, pulverant material 24 may form a semi-solid layer of bonded granules of pulverant material 24. Partially sintered layer 28 is such a conglomeration of granules (FIG. 2, 50) of pulverant material 24 that have been partially sintered as they passed between rollers 26.

Additive manufacturing by laser occurs at workstage 30. Workstage 30 as shown in FIG. 1 includes guide rollers 32, movable platform 34, and stack 36. Guide rollers 32 may be attached to a motor (not shown) in order to rotate at a specified speed. Movable platform 34, as shown in FIG. 1, is a plate with a mechanism for moving in at least one direction. In alternative embodiments, depending on the method of additive manufacturing used, it may be desirable to surround movable support 34 with a housing (not shown). For example, in Laser Object Manufacturing, sections of unwanted material may be laser cut in a raster pattern, such that after manufacturing is complete the unwanted material may be easily removed. Without a housing, the unwanted material could fall away immediately, and would not provide support for additional additively manufactured layers. In alternate additive manufacturing processes, such as Laser Additive manufacturing, no housing is required. Stack 36 includes a partially or fully built additively manufactured component or article. In addition, as described above, stack 36 may include material which will be removed upon completion of the additively manufactured article.

Radiation system 40 as shown in FIG. 1 includes radiation source 42, mirror 44, movable optical head 46, and radiation beam 48. Radiation source 42 as shown in FIG. 1 is a laser. For example, radiation source 42 may be a carbon dioxide (CO2) laser. In alternative embodiments, radiation source 42 could be any source of radiation capable of sintering or melting pulverant material 24 in partially sintered layer 28. For example, radiation source 42 in another embodiment could be an electron beam. Minor 44 and movable optical head 46 are any optical components capable of directing the radiation toward a desired location. Radiation beam 48 illustrates the path that radiation from radiation source 42 might take toward partially sintered layer 28. Depending on the type of device used for radiation source 42, mirror 44 and/or movable optical head 46 may not be necessary.

When in use, hopper 22 dispenses pulverant material 24 to rollers 26. Rollers 26 compress and/or heat pulverant material 24 to form partially sintered layer 28. Partially sintered layer 28 is moved from material supply section 20 to workstage 30 by guide rollers 32. Guide rollers 32 position partially sintered layer 28 above movable support 34 and/or stack 36 for additive manufacturing. Radiation system 40 additively manufactures a layer on top of movable support 34 and/or stack 36. Radiation source 42 generates radiation beam 48, which is directed by minor 44 and movable optical head 46 to sinter and/or cut portions of partially sintered layer 28 to the adjacent, underlying layer of stack 36 (or, for the first layer of the part, to movable support 34). Guide rollers 32 then advance the next section of partially sintered layer 28 into position on workstage 30. The process is repeated until the additive manufacturing of the desired article is complete.

Partially sintered layer 28 presents advantages over the prior art. For example, partially sintered layer 28 does not leave carbonaceous deposits as a layer of sinterpaper may because partially sintered layer 28 does not include carbon-based paper. Additionally, the area density of pulverant material 24 in partially sintered layer 28 may be accurately controlled, because partially sintered layer 28 does not allow pulverant material 24 to accumulate more densely in some areas than others as sinterpaper does. Further, partially sintered layer 28 does not suffer from the disadvantages of using virgin unsintered powder, such as clumping and relatively higher oxidation rates in the additive manufacturing chamber. Clumping is eliminated because granules of pulverant material 24 are bonded to one another as opposed to free-flowing. Oxidation rates are reduced as granules of pulverant material 24 which are at least partially bonded have a lower surface-area-to-volume ratio than unsintered powder.

Alternative embodiments and improvements may be made which exploit further benefits of the invention. For example, partially sintered layer 28 may be heated to a temperature close to but less than the melting temperature of pulverant material 24 prior to advancing to workstage 30. The closer the heating temperature is to the melting temperature of pulverant material 24, the less energy input is required during additive manufacturing to sinter or melt partially sintered layer 28. For example, partially sintered layer 28 may be heated by guide rollers 32 as is passes along them. Material with a higher temperature takes less time to sinter or cut using radiation source 42. Often, radiation source 42 is an expensive component to purchase, and reducing the time that component must be used to create each layer is economically desirable. By using cheaper heating mechanisms such as a resistive heating coil to preheat partially sintered layer 28, sintering time using radiation source 42 may be decreased, thus increasing manufacturing throughput.

Additionally, alternative embodiments may use separate systems for the formation of the feedstock sheet and for additive manufacturing. Thus, an additive manufacturing device may be fed feedstock that already comprises a fully-dense sheet of bonded pulverant material. In such systems, the additive manufacturing apparatus need not have any capability to form the feedstock layer, and so its associated supply system may include fewer components. For example, in such a system the supply system may include only feed rollers and a heater.

FIG. 2 is a simplified cross-section of partially sintered layer 28. Partially sintered layer 28 is made of granules 50, and has a thickness 52. Granules 50 are partially sintered quanta of pulverant material 24 (FIG. 1) which have been compressed and/or heated by rollers 26 (FIG. 1). Granules 50 are made of any material that can be sintered, such as metals and polymers. Typically, granules 50 have a radius between 1 μm and 50 μm. The nip between rollers 26 (FIG. 1) is proportional to thickness 52. Thickness 52 determines the thickness of each layer of any additively manufactured article made by system 10 (FIG. 1). Thickness 52 is typically between 0.5 mm and 2.0 mm. By partially sintering granules 50 to one another within partially sintered layer 28, additive manufacturing time can be reduced and the detriments of using unsintered powder or of using sinterpaper are obviated.

### LISTING OF POTENTIAL EMBODIMENTS

One embodiment of the invention is an additive manufacturing apparatus comprising a supply system for delivering a layer of a partially sintered pulverant material to an additive manufacturing station, and a selective heating system that is capable of directing a focused radiation beam onto the layer at the station to sinter selected regions of the based upon data that defines a slice of an object to be manufactured. The additive manufacturing apparatus may includes two rollers, at least one of which is heated. The additive manufacturing apparatus may further comprising a hopper capable of delivering the pulverant material to the supply system. The additive manufacturing apparatus may include pulverant material with more than one distinct material. The additive manufacturing apparatus may use a layer which is a fully-dense, pre-fabricated sheet of sintered pulverant material. The additive manufacturing apparatus may further comprise a guiding system that is capable of transferring the layer from the supply system to the station. The additive manufacturing apparatus may have a guiding system that is heated. The focused radiation beam may be a laser such as a CO2 laser, or it may be an alternative radiation source such as an electron beam, and the pulverant material may be a high temperature superalloy. The additive manufacturing apparatus may include a movable optical head.

The invention also includes a method of forming an object comprising (a) forming a partially sintered layer from a pulverant material, the partially sintered layer having a thickness; (b) advancing the partially sintered layer to a stage; (c) selectively sintering at least a portion of the partially sintered layer above the stage based upon data that defines an object; (d) cutting at least a portion of the partially sintered layer above the stage; (e) incrementally lowering the stage; (f) repeating steps (b)-(e) until the object is complete; and (g) removing the object from the stage. Forming the partially sintered layer of pulverant material may include: dispensing the pulverant material from a hopper to a supply system, wherein the supply system includes a first roller and a second roller separated by a nip; heating at least one of the first roller and the second roller to a temperature sufficient to at least partially melt or sinter the pulverant material; and rotating the first heated roller and the second heated roller to compress the pulverant material and generate a partially sintered layer of pulverant material. The method may also include dispensing pulverant material from a plurality of hoppers, each having a respective pulverant material. The method may include using slices of the plurality of pulverant materials to form an object. The method may also include advancing the partially sintered layer further by heating the partially sintered layer to a temperature less than a melting temperature of the pulverant material. This may be accomplished by advancing the partially sintered layer using a heated guide roller, which may include heating the partially sintered layer to a temperature less than the melting temperature of the partially sintered layer. The pulverant material may be a high temperature superalloy.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An additive manufacturing apparatus comprising:
a supply system for delivering a layer of a partially sintered pulverant material to an additive manufacturing station; and
a selective heating system that is capable of directing a focused radiation beam onto the layer at the station to sinter selected regions of the based upon data that defines a slice of an object to be manufactured.

2. The additive manufacturing apparatus of claim 1, wherein the supply system includes two rollers, at least one of which is heated.

3. The additive manufacturing apparatus of claim 1, and further comprising a hopper capable of delivering the pulverant material to the supply system.

4. The additive manufacturing apparatus of claim 1, wherein the pulverant material may include more than one distinct material.

5. The additive manufacturing apparatus of claim 1, wherein the layer is a fully-dense, pre-fabricated sheet of sintered pulverant material.

6. The additive manufacturing apparatus of claim 1, and further comprising a guiding system that is capable of transferring the layer from the supply system to the station.

7. The additive manufacturing apparatus of claim 1, wherein the guiding system is heated.

8. The additive manufacturing apparatus of claim 1, wherein the focused radiation beam is a laser.

9. The additive manufacturing apparatus of claim 1, wherein the pulverant material is a high temperature superalloy.

10. The additive manufacturing apparatus of claim 8, wherein the laser is a CO2 laser.

11. The additive manufacturing apparatus of claim 1, wherein the focused radiation beam is an electron beam.

12. The additive manufacturing apparatus of claim 8, further comprising a movable optical head.

13. A method of forming an object comprising:
(a) forming a partially sintered layer from a pulverant material, the partially sintered layer having a thickness;
(b) advancing the partially sintered layer to a stage;
(c) selectively sintering at least a portion of the partially sintered layer above the stage based upon data that defines an object;
(d) cutting at least a portion of the partially sintered layer above the stage;
(e) incrementally lowering the stage;
(f) repeating steps (b)-(e) until the object is complete; and
(g) removing the object from the stage.

14. The method of claim 13, wherein forming the partially sintered layer of pulverant material comprises:
dispensing the pulverant material from a hopper to a supply system, wherein the supply system includes a first roller and a second roller separated by a nip;
heating at least one of the first roller and the second roller to a temperature sufficient to at least partially melt or sinter the pulverant material; and
rotating the first heated roller and the second heated roller to compress the pulverant material and generate a partially sintered layer of pulverant material.

15. The method of claim 14, wherein dispensing the pulverant material further comprises dispensing pulverant material from a plurality of hoppers, each having a respective pulverant material.

16. The method of claim 15, wherein the object is made of slices of the plurality of pulverant materials.

17. The method of claim 13, wherein advancing the partially sintered layer further comprises heating the partially sintered layer to a temperature less than a melting temperature of the pulverant material.

18. The method of claim 17, wherein heating the partially sintered layer includes advancing the partially sintered layer using a heated guide roller.

19. The method of claim 18, wherein heating the partially sintered layer with the heated guide roller includes heating the partially sintered layer to a temperature less than the melting temperature of the partially sintered layer.

20. The method of claim 17, wherein the pulverant material is a high temperature superalloy.
